(19) United States
(12) Patent Application Publication
(10) Pub. No.: US 2018/0260978 A1
(43) Pub. Date: Sep. 13, 2018

(54) Heat Map Tiles

(71) Applicant: SAP SE, Walldorf (DE)

(72) Inventors: Ammu S. Ansari, Alappuzha (IN); Narayani V, Bangalore (IN); Syed Aleemuddin Noor, Bangalore (IN); Subrat Kumar Giri, East Singhbhum (IN)

(21) Appl. No.: 15/455,938

(22) Filed: Mar. 10, 2017

(51) Int. Cl. G06T 11/00

(52) U.S. Cl. CPC G06T 11/001; G06F 3/04817

(57) ABSTRACT

Disclosed herein are system, method, and computer program product embodiments for generating heat map colored tiles. A tile may be a graphical user interface object depicting a data object. One or more tiles may be organized and sorted by a numerical value associated with one or more data objects. The tiles may be colored in a heat map configuration based on the numerical value and may also provide a command interface, allowing users to quickly interact with the depicted data objects. The organization and coloring of a set of tiles may allow users to quickly visualize data and make more informed decisions.

### BACKGROUND

As information grows, sorting and visualizing the information are tasks that must be accomplished to more effectively and efficiently utilize the information. Charts or tables may be employed to organize data, but these methods of organization and visualization are limited by the amount of information that can be expressed. As information grows more complex and as more variables must be easily accessed, newer ways of information organization and visualization are required. Individuals who must make decisions based on the data require a way to quickly view and manipulate the data. Further, visualization and interaction with the data must be intuitive and efficient so that users can quickly access and utilize the information without a steep learning curve.

### BRIEF DESCRIPTION OF THE DRAWINGS

The accompanying drawings are incorporated herein and form a part of the specification.

FIG. 1 is a block diagram of a tile generation system, according to some embodiments.

FIG. 2A is a diagram of a graphical user interface display depicting tiles, according to some embodiments.

FIG. 2B is a diagram of a tile depicting command interface options, according to some embodiments.

FIG. 3A is a flowchart illustrating a method for generating heat map tiles, according to some embodiments.

FIG. 3B is a flowchart illustrating a method for mapping data objects to a color, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a heat map tile generation system.

Tiles may be used to display data in a graphical user interface form. In an embodiment, a tile may display information related to a data object. Tiles may be organized and sorted by a value associated with the data object. Tiles may also be detailed visually (and/or using another display attribute) to highlight information associated with data object. For example, tiles may be organized and sorted by a numerical value associated with the data object and may be colored. It is noted that this disclosure is not limited to this example, and tiles may be organized and sorted by other than numerical values as further discussed below. Coloring may occur in a heat map configuration. Applying color to a tile in a heat map configuration may generate a heat map tile. This color-coded sorting allows a user to quickly visualize data and make more informed decisions. In an embodiment, the tiles may be colored to form a spectrum to indicate the magnitude of a numeric value associated with a particular tile. In an embodiment, tiles may display a ranking to depict data object data. The heat map tile configuration also provides a command interface, allowing users to quickly interact with the data provided.

In an embodiment, heat map tiles may be graphical user interface objects that display information related to data objects of a dataset. One or more tiles may be used to depict information associated with a data object. A data object may be a set of variables organized by a common variable. The variables may include alphabetic information, numeric information, Boolean values, alphanumeric information, textual information, image information, video information, and/or audio information, to name just a few examples. A dataset may include one or more data objects. A set of heat map tiles may be generated to provide a visual representation of the data objects of a dataset. Heat map tiles may also include command interface options, allowing a user to further interact with the heat map tile and the underlying data object.

In an embodiment, a data object may be a representation of an expense receipt. Variables associated with the expense receipt may include an employee name, a category for the type of expense, the location where the expense was charged, the amount of the expense, the date of the expense, and/or additional notes related to the expense. A dataset may include a set of data objects representing expense receipts. Based on this dataset, heat map tiles may be generated where each tile represents an expense receipt.

In an embodiment, a data object may be a representation of a job applicant. Variables associated with the job applicant may include the applicant name, qualifications, education, experience, years of experience, grade point average, and/or a test score relevant to the application process. A dataset may include a set of data objects representing job applicants. Based on this dataset, heat map tiles may be generated where each tile represents a job applicant.

In an embodiment, a dataset may be sorted according to a numeric value associated with a variable common across the data objects in the data set. The data objects may then be associated with a tile. To generate the heat map aspect of the tiles, each tile may be assigned a color. The color may be representative of the numerical value associated with the data object and also reflect the relative distance between the mean, or average, of the numerical values and the value associated with the particular data object. For example, a green-yellow-red spectrum of colors may be used to color the tiles to generate a visual indication of the relative magnitudes of each numerical value. By sorting the data objects using heat map tiles and coloring the tiles to represent relative magnitudes, users may quickly view the data objects in a dataset as well as their relative importance regarding a variable.

These features will now be discussed with respect to the corresponding figures.

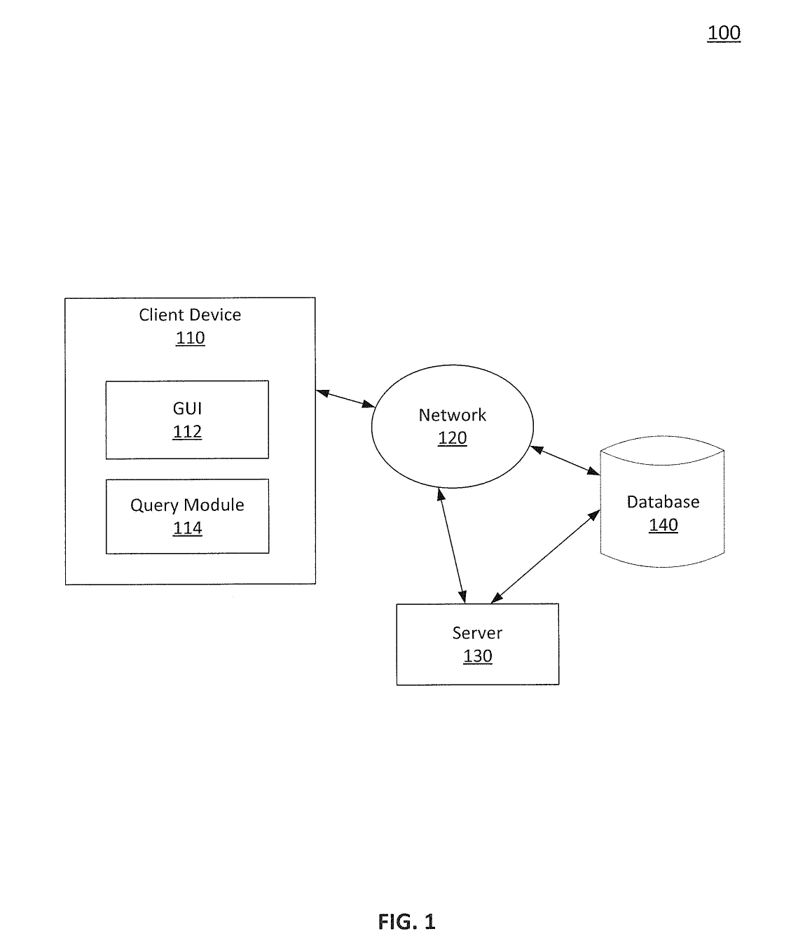

FIG. 1A is a block diagram of a tile generation system 100, according to some embodiments. In an embodiment, tile generation system 100 comprises a client device 110, a network 120, a server 130, and database 140. The client device 110 may include a graphical user interface (GUI) 112 and a query module 114. In an embodiment, tile generation system 100 allows client 110 to interact with server 130 and database 140 to generate graphical user interface tiles on GUI 112. In an embodiment, query module 114 located on client device 110 may be configured to generate heat map tiles. In an embodiment, server 130 may be configured to generate heat map tiles and transfer the heat map tiles to client device 110 via network 120

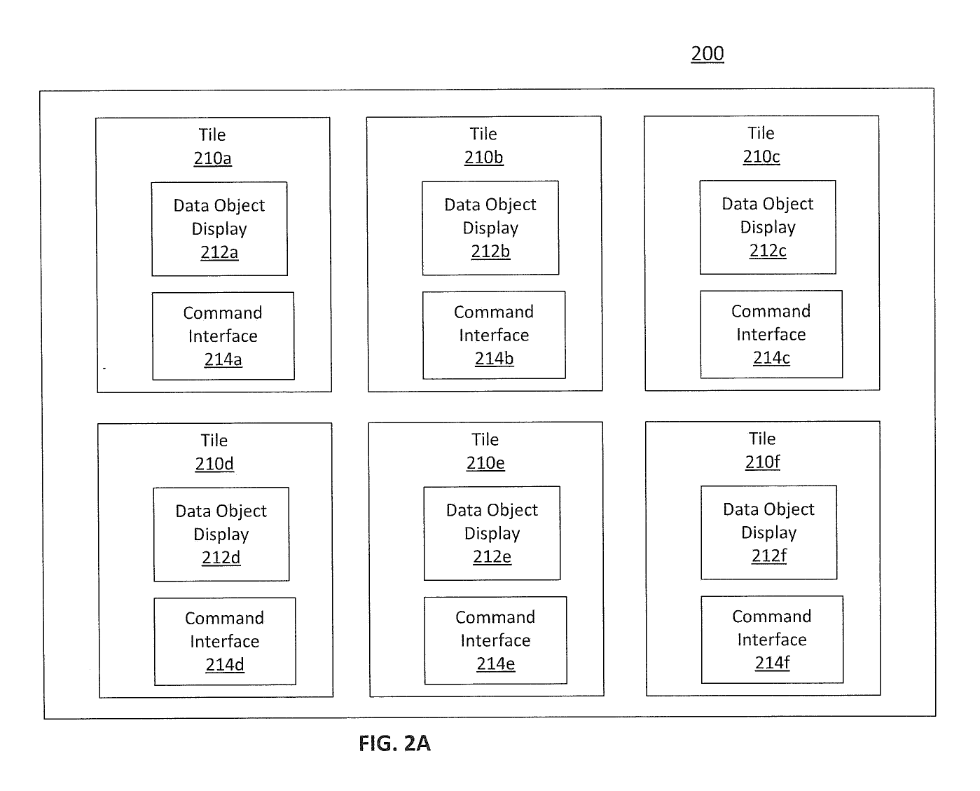

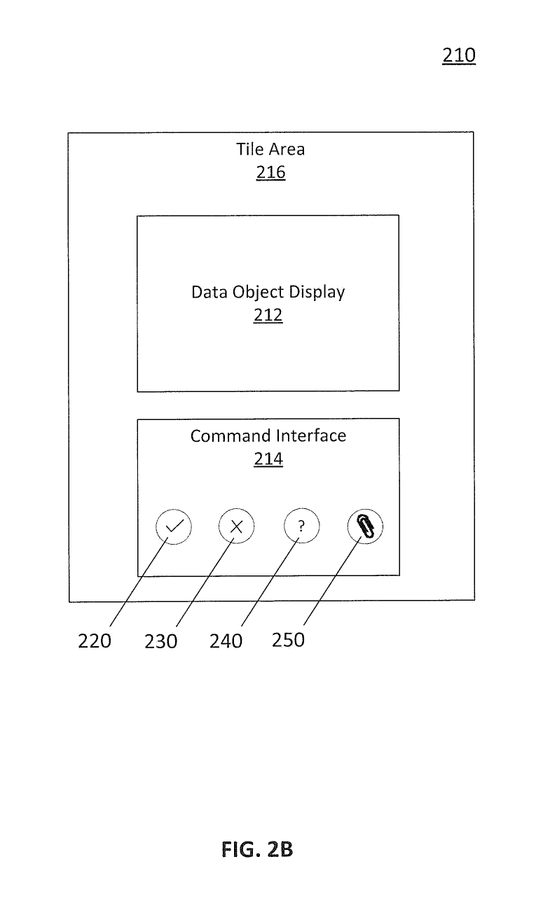

In an embodiment, client device 110 may be a computing platform, such as but not limited to smartphones, tablet computers, laptop computers, desktop computers, web browsers, or any other computing platform, device, component or apparatus. Client device 110 may include a GUI 112 and a query module 114. GUI 112 may be a visual display device, such as, for example, a display screen, a monitor, a touch screen, and/or television. GUI 112 may also include one or more processors and memory required to generate a visual display. GUI 112 may instantiate one or more heat map tiles after the heat map tiles are generated. GUI 112 may also accept inputs and/or interactions with the heat map tiles. For example, a user may interact with a displayed heat map tile to provide an acceptance or rejection to the underlying data object, add information, an inquiry, and/or variable data to the underlying data object, obtain more information associated with the data object depicted by the heat map tile, and/or visually alter the size and/or location of the heat map tile. An embodiment of a display including heat map tiles is depicted in FIG. 2A. This embodiment may be displayed on client device 110 using GUI 112.

In an embodiment, query module 114 is coupled to GUI 112 and performs processing required to generate heat map tiles. Query module may include one or more processors, routers, moderns and/or antennae configured to send and/or receive information to server 130 and/or database 140 via network 120. Query module 114 may interface with network 120 to communicate with server 130 and database 140. Query module 114 may utilize a network protocol to send and receive data over network 120 to server 130. Network 120 may be a network capable of transmitting information either in a wired or wireless manner and may be, for example, the Internet, a Local Area Network, or a Wide Area Network. The network protocol may be, for example, a hypertext transfer protocol (HTTP), a TCP/IP protocol, Ethernet, cellular, Bluetooth, or an asynchronous transfer mode, to name just a few examples, or any combination thereof.

In an embodiment, data objects used for generating heat map tiles may be stored in database 140. Database 140 may be a memory storage device. In an embodiment, database 140 includes one or more processors configured to transmit and receive data objects and/or changes associated with stored data objects.

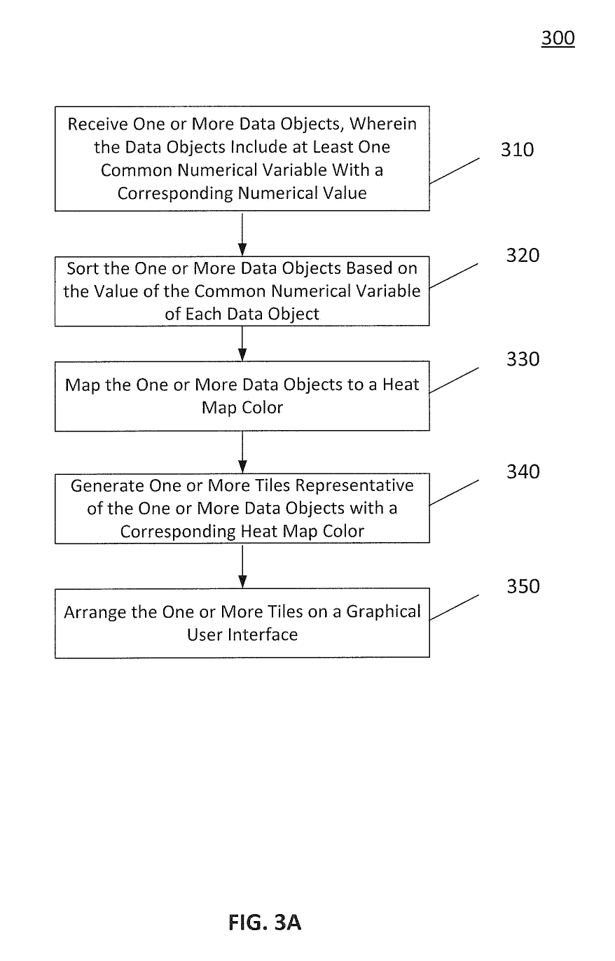

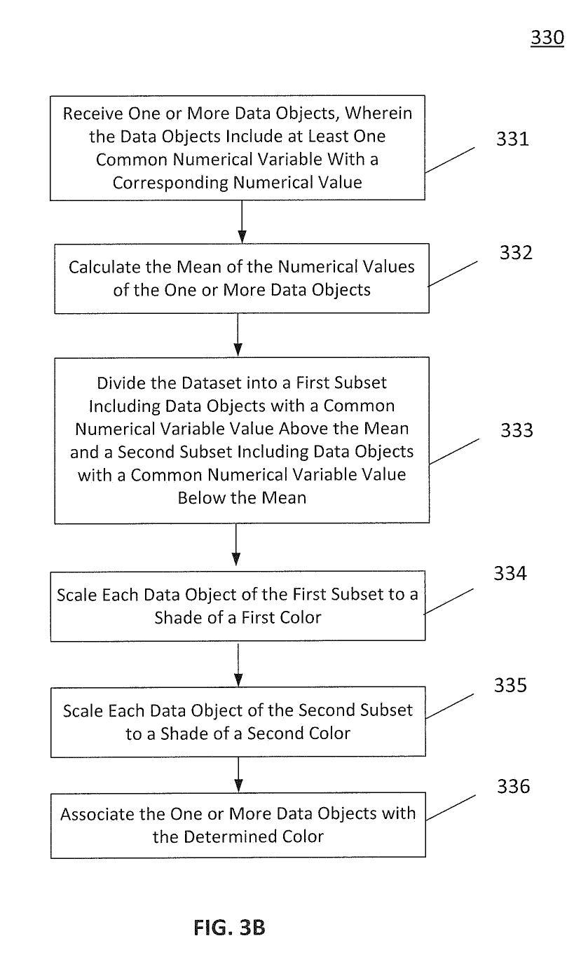

In an embodiment, a user may seek to view a dataset at client device 110. The dataset may include one or more data objects. The user may utilize GUI 112 to initiate a command to fetch the desired dataset. If the dataset already resides in client device 110, GUI 112 may fetch the data from client device 110 memory and generate corresponding heat map tiles. If the dataset and corresponding data objects reside in database 140, client device 110 may utilize query module 114 to fetch the dataset. Query module 114 may send a query via network 120 to server 130. In an embodiment, server 130 may be executing a database management system capable of interfacing with database 140. In response to the query from query module 114, server 130 may fetch the dataset from database 140 and return the requested dataset to client device 110 via network 120. In an embodiment, client device 110, using GUI 112 and/or query module 114, processes the dataset to generate heat map tiles. FIGS. 3A-3B provide an embodiment for generating a heat map tiles. In an embodiment, server 130 may generate the heat map tiles and transmit to client device 110 information required for displaying the heat map tiles. In an embodiment, both client device 110 and server 130 may perform a subset of the steps required to generate the heat map tiles. FIGS. 3A-3B are further described below.

FIG. 2A is a graphical user interface (GUI) display 200 depicting tiles 210, according to some embodiments. In an embodiment, GUI display 200 may be displayed on GUI 112 of client 110 as described with reference to FIG. 1. GUI display 200 may display one or more tiles 210. Tiles 210 may be graphical user interface representations of data objects in a dataset. Tiles 210 may each include a data object display 212 and a command interface 214.

In an embodiment, tiles 210 may be arranged in rows and columns on GUI display 200. In an embodiment, tiles 210 may be free form without a strict organizational pattern. In an embodiment, a user may interact with GUI display 200 to alter the location of tiles 210. For example, if tiles 210 begin in a free form configuration without an organizational pattern, a command may be received at GUI display 200 to sort the tiles 210 according to variables associated with the data objects. An embodiment describing the generation and organization of tiles 210 is described below with reference to FIGS. 3A-3B.

In an embodiment, tiles 210 may be configured into a “heat map” configuration. A tile 210 may be a graphical user interface depiction of a data object. In the example embodiment shown in FIG. 2A, GUI display 200 may depict six tiles 210a-210f with each tile 210 representing a different data object. Although six tiles 210a-210f are shown in FIG. 2A, this disclosure is applicable to any number of tiles 210 in GUI display 200. Taken together, tiles 210a-210f may represent a dataset of data objects. A heat map configuration may sort the tiles 210a-210f according to an attribute associated with each data object. For example, tiles 210a-210f may be sorted based on alphabetic information, numeric information, Boolean values, alphanumeric information, textual information, image information, video information, and/or audio information, to name just a few examples. In an embodiment, sorting may occur from highest to lowest, from lowest to highest, most frequently occurring, and/or least frequently occurring. Based on the sorting of the data object, tiles 210a-210f may be arranged in GUI display 200, in, for example, rows and columns.

For example, data objects in a dataset may represent expenses. Each data object may reflect an expense receipt, including information related to the expenditure as well as the amount of the expenditure. Tiles 210a-210f may represent each expense receipt data object. In an embodiment, tiles 210a-210f may be sorted based on the amount of the expenditure. For example, tile 210a may reflect the expense receipt data object with the highest expenditure amount while tile 210f may reflect the expense receipt data object with lowest expenditure amount. Tiles 210b-210e may be sorted to reflecting a descending expenditure amount from 210a to 210f. Based on this sorting, tiles 210a-210f may be arranged on GUI display 200. In an embodiment, tiles 210a-210f may be arranged in rows and columns based on the size of GUI display 200. The arrangement and size of each tile 210 may be measured based on the pixels of GUI display 200. Arranging tiles 210a-210f in a descending order allows a user to visually identify the relative magnitudes of a numerical value associated with each data object represented by a tile 210. In an embodiment, more than or less than six tiles 210 may be utilized to depict different datasets with a variable number of data objects. In an embodiment, each tile 210 represents a data object.

In an embodiment with many tiles 210, GUI display 200 may display smaller tiles 210. A user may interact with GUI display 200 in order to display more or less tiles 210. For example, a user may zoom in or zoom out of GUI display 200, changing the number of display tiles 210. In an embodiment, one or more tiles 210 may be hidden either when initially generated or by user interaction. A user may interact with GUI display 200 to view one or more hidden tiles 210.

In an embodiment, tiles 210 may be colored to add allow users to visually recognize information among tiles 210. In an embodiment, tiles 210 may be colored to highlight a discrete category associated with the data objects in a dataset. For example, in an expense report embodiment, tiles 210 may be colored to highlight categories related to expenditures, such as, for example, medical expenses, books and periodical expenses, and/or cleaning and maintenance expense. Each category may be assigned a color. Tiles 210 may be colored based on the category of the expense.

In an embodiment, tiles 210 may be colored in a “heat map” configuration. A heat map configuration may utilize a spectrum of colors to depict numerical values, showing the relative magnitude of each numerical value using color. The spectrum of colors may be a grayscale ranging from black to white. In an embodiment, the spectrum of colors may be colors other than black and white used to signify numerical magnitudes.

As applied to tiles 210, each tile 210a-210f may be assigned a different color based on a numerical value associated with the data object depicted by each tile 210a-210f. For example, in an embodiment where tiles 210a-210f depict data objects such as expense receipts, the expenditure amount may be the numerical value used for generating the tile 210 color. In a grayscale embodiment, the expenditure amount may be scaled such that the highest expenditure has the darkest or blackest color while the lowest expenditure has the lightest or whitest color. In an embodiment where colors other than black and white are used, the tiles 210 may be colored using a red-yellow-green spectrum of colors. In an embodiment, the color red may represent the highest expenditure, the color green may represent the lowest expenditure, and the color yellow may represent the mid-point of the expenditures associated with the data objects in the dataset. In an embodiment, the red-green-blue color palette may be used to generate the red-yellow-green spectrum. An embodiment describing a method for generating colors for tiles 210 is described with reference to FIGS. 3A-3B.

In an embodiment, sorting and coloring tiles 210 based on a numerical value associated with data objects of a dataset allow users to quickly visualize the information related to the data object. Further, the tiles 210 provide a visual ranking. This ranking may allow a user to make more informed-decisions regarding the dataset. This ranking also allows a user to more quickly make decisions by being able to quickly visualize the data objects based on color. By associating color with relative magnitudes, users may be able to quickly distinguish between different tiles 210 and data objects.

To provide more information to a user, tiles 210 may include a data object display 212. In an embodiment, data object display 212 may depict information associated with a data object depicted by a tile 210. Data object display 212 may depict one or more variables associated with the data object. Providing information related to data object variables allows a user to explore more information related to each data object. For example, in an embodiment where data objects represent expense reports, variables that may be displayed by data object display 212 may include an employee name, a category for the type of expense, the location where the expense was charged, the amount of the expense, the date of the expense, and/or additional notes related to the expense. In an embodiment where a data object represents a job applicant, data object display 212 may depict variable information including the applicant name, qualifications, education, experience, years of experience, grade point average, and/or a test score relevant to the application process.

In an embodiment, each tile 210a-210f may depict an associated data object display 212a-212f. In an embodiment, data object display 212 may be displayed when tiles 210 are generated. In an embodiment, one or more variables associated with the data object depicted by tile 210 may be hidden. A user may interact with a tile 210 to display hidden data object information in data object display 212.

In an embodiment, a user may interact with a tile 210 using a command interface 214. Each of tiles 210a-210f may depict a corresponding command interface 214a-214f. A command interface 214 may be a graphical user interface which provides any number of options for a user to interact with a tile 210. As described with respect to FIG. 1, command interface 214 may be used to allow a user to interface with query module 114. In an embodiment, command interface 214 may allow for a user to zoom in or zoom out and/or enlarge or shrink a tile 210. Command interface 214 may allow a user to move a tile 210 to another location on GUI display 200. In an embodiment, command interface 214 may be a menu and/or a series of icons displayed, granting options for data object interaction. In an embodiment, based on the data object and the variables associated with the data object, options depicted by command interface 214 may be different. For example, tile 210a may depict a data object of an expense receipt requiring approval while tile 210b may depict a data object of an expense receipt that has already been approved. Command interface 214a associated with tile 210a may allow a user the option to approve the expense receipt while command interface 214b associated with tile 210b may not depict this option. An embodiment of command interface 214 is further described with reference to FIG. 2B.

Tiles 210 may be used to depict datasets of data objects. Data objects may be arranged and organized according to a numerical value of a variable associated with the data objects. Tiles 210 may also be colored to provide a view of the relative magnitude of the numerical value. Example embodiments of expense report tiles and job applicant tiles have been described above. Other embodiments may include different data types associated with the data objects. For example, a data object may be an audiovisual file with statistics corresponding to the video. For example, the variables may include the number of times the video has been accessed and/or viewed, the length of the video, the name of the video, categorical information related to the video, and/or the date of video creation. In an embodiment, data object display 212 may display and/or stream the video as well as provide variable information. Command interface 214 may allow a user to play, pause, stop, rewind, and/or fast-forward the video.

In an embodiment, tiles 210 may be used to highlight articles and/or text content. Coloring of tiles 210 may be used to depict a success metric and/or a number of views or votes associated with the content. In an embodiment, data objects may include tasks or project information. Sorting and color-coding may allow the tiles 210 to depict priority regarding task completion as well as due dates. Flexibility regarding the use of tiles 210 as applied to various data objects allows GUI display 200 to display different types of datasets while effectively organizing information.

FIG. 2B is a diagram of a tile 210 depicting command interface options, according to some embodiments. Tile 210 may be an embodiment of a tile as depicted in, and described with reference to, FIG. 2A. Tile 210 may include a data object display 212, command interface 214, and tile area 216. Command interface 214 may include, for example, an accept icon 220, a reject icon 230, an inquire icon 240, and an attachment icon 250. Icons 220-250 may be graphical user interface display objects allowing a user to interact with a data object depicted by tile 210.

In an embodiment, tile 210 may include a data object display 212. As explained with reference to FIG. 2A, data object display 212 may present information related to the variables of the data object being represented by tile 210. If the data object is a file, such as a text, image, audio, and/or video file, data object display 212 may also serve as an interface to display the data object file.

To interact with the data object represented by tile 210, a user may utilize command interface 214. As explained with reference to FIG. 2A, command interface 214 may allow a user to alter the visual size and/or information displayed on tile 210. Command interface 214 may also provide a list of commands using icons and/or menus. Commands may allow a user to view more information about data objects and/or manipulate data objects. In an embodiment, command interface 214 may include an accept icon 220, a reject icon 230, an inquire icon 240, and an attachment icon 250. In an embodiment, icons 220-250 may be used to interface with query module 114 as described with reference to FIG. 1. Icons 220-250 may be used to quickly append information to a data object represented by a tile 210. Icons 220-250 may allow a user to add variable information to a data object.

In an embodiment, icons 220-250 may be used when an administrator is reviewing information and must grant approval. Accept icon 220 may be used to grant an acceptance of a data object. In an embodiment, accept icon 220 may write a descriptor and/or additional variable data to the data object, signifying that a user has accepted the data in the data object. In an embodiment, accept icon 220 may be utilized to signify that a user has reviewed the data object. In an embodiment, accept icon 220 may be utilized among more than one tile 210 to mark certain tiles 210 with a special status. For example, a user may tag or select certain tiles 210 among a set of tiles 210 using accept icon 220.

Reject icon 230 may be used to reject a data object. In an embodiment, reject icon 220 may write a descriptor and/or additional variable data to the data object, signifying that a user has rejected the data in the data object. In an embodiment, reject icon 230 may be utilized to signify that a user has reviewed the data object. In an embodiment, reject icon 230 may be utilized among more than one tile 210 to mark certain tiles 210 with a special status. For example, a user may tag or select certain tiles 210 among a set of tiles 210 using reject icon 230. In an embodiment, a user may utilize both accept icon 220 and reject icon 230 to mark different tiles with different statuses.

Inquire icon 240 may be used to request more information pertaining to a data object. In an embodiment, inquire icon 240 may write a descriptor and/or additional variable data to the data object, signifying that a user requires more information regarding the data object before determining whether to reject or accept the data. In an embodiment, inquire icon 240 may be utilized to signify that a user has reviewed the data object but has not yet accepted or rejected the data. In an embodiment, inquire icon 240 may be utilized among more than one tile 210 to mark certain tiles 210 with a special status. For example, a user may tag or select certain tiles 210 among a set of tiles 210 using inquire icon 240. A user may utilize inquire icon 240 to add additional notes to the data object. In an embodiment, a user may utilize accept icon 220, reject icon 230, and inquire icon 240 to mark different tiles with different statuses.

In an embodiment, attachment icon 250 allows a user to view information related to the data object that may not appear in data object display 212. For example, the data object depicted by tile 210 may include a text and/or image attachment. Selecting attachment icon 250 may display attachments related to the data object. In an embodiment, attachment icon 250 may allow a user to save an attachment to the data object depicted by tile 210. For example, to justify an acceptance using accept icon 220, a user may also need to attach an image of a signed paper form to the data object for storage. The user may utilize attachment icon 250 to generate an interface for uploading and/or associating an image of a signed paper form with the data object. Allowing for this manipulation of data grants the user the ability to view and/or add more data associated with a data object.

In an embodiment, an administrator may utilize icons 220-250 to review expense reports. For example, an administrator may view one or more tiles 210 representing expense reports that may be approved or rejected for reimbursement. In an embodiment, tile 210 may represent an expense report data object, and data object display 212 may display variables related to the expense report such as the name of the person submitting the expense report, the place of expenditure, and/or the amount of the expense. Based on a review of the data, the administrator may accept the expense report for reimbursement using accept icon 220, reject the expense report using reject icon 230, or request more information using inquire icon 240. To aid in the determination, the administrator may use attachment icon 250 to view attachments to the data object, such as, for example, an image of the receipt and/or accompanying forms related to the expenditure. In accepting or rejecting the expense report, the administrator may further utilize attachment icon 250 to add additional attachments and/or notes to the data object.

In an embodiment, data objects may be stored remotely from a device displaying tile 210. For example, with reference to FIG. 1, GUI 112 on client device 110 may display tile 210. Data objects, however, may be stored in a remote database 140. For a user to utilize attachment icon 250 in this case for adding information to the data object, client device 110 will utilize query module 114 to transmit the added attachment to database 140 via network 120 and possibly server 130. Client device 110, server 130, and/or database 140 may associate the attachment with the data object.

Returning to FIG. 2B, tile 210 may include a tile area 216. Tile area 216 may be a graphical user interface component where data object display 212 and command interface 214 reside. In an embodiment, data object display 212 and/or command interface 214 may be overlayed on top of tile area 216.

In an embodiment, tile area 216 may be colored. For example, in a heat map configuration where multiple tiles 210 are sorted, arranged, and colored, tile area 216 may display as the designated color. Multiple tiles 210 may display different colors in tile area 216. For example, in an embodiment where the color red is associated with the highest numerical value, tile area 216 may be red while data object display 212 depicts the numerical value in addition to other data object information. In the same set of tiles 210, another tiles may depict a green tile area 216 representing the lowest numerical value.

FIG. 3A is a flowchart illustrating a method 300 for generating heat map tiles, according to some embodiments. Method 300 shall be described with reference to FIGS. 1 and 2A-2B. However, method 300 is not limited to that example embodiment.

As referenced in FIGS. 2A and 2B, tiles 210 may be depictions of data objects in a dataset. To generate one or more heat map tiles, the tiles 210 may be sorted, arranged, and/or colored. This process allows for better visualization of data objects within a dataset by showing the arrangement as well as a relative numerical value common across the dataset.

Method 300 may be performed by processing logic that may comprise hardware (e.g., circuitry, dedicated logic, programmable logic, microcode, etc.), software (e.g., instructions executing on a processing device), or a combination thereof. In an embodiment, method 300 may be performed by a client device 110. In an embodiment, method 300 may be performed by a server 130. It is to be appreciated that not all steps may be needed to perform the disclosure provided herein. Further, some of the steps may be performed simultaneously, or in a different order than shown in FIG. 3A, as will be understood by a person of ordinary skill in the art.

At 310, a server 130 and/or a client 110 may receive one or more data objects, wherein the data objects include at least one common numerical variable with a corresponding numerical value. In an embodiment, the data objects may be received from a database 140 over a network 120. The data objects may be a set of variables organized by a common variable. The variables may include alphabetic information, numeric information, Boolean values, alphanumeric information, textual information, image information, video information, and/or audio information. A dataset may refer to one or more data objects that are grouped together. In an embodiment, a dataset may contain data objects that share a common numerical variable. For example, in an expense report embodiment, data objects may be expense receipts and the amount of the expense may be the common numerical variable. Each data object in a dataset may store an associated numerical value associated with the common numerical variable, such as, for example, $3000 for the amount of the expense.

At 320, the server 130 and/or the client 110 may sort the one or more data objects based on the value of the common numerical variable of each data object. In an embodiment, each data object of a dataset may be analyzed and arranged according to the numerical value of a common numerical variable shared by the data objects. In an embodiment, sorting may occur by arranging the data object numerical value from highest to lowest, from lowest to highest, most frequently occurring, and/or least frequently occurring. As a result, the data objects may also be sorted in this manner.

To arrange the data objects, an array, list, and/or table may be utilized. In an embodiment, the data objects may be arranged by assigning a value to a “position” variable associated with the data object. For example, one or more processors may write a “1” to the position variable to signify that the data object is first. In an embodiment where the data object may be displayed using a tile 210 in a grid or array configuration, one or more processors may write a row and/or column position to the variable to signify the tile 210 location.

At 330, the server 130 and/or the client 110 may map the one or more data objects to a heat map color. The heat map color may be the color that appears in tile area 216 of a tile 210 depicting a data object. The heat map color may be a grayscale and/or a color spectrum indicative of the magnitude of the numerical value of the common numerical variable associated with each data object. Mapping the one or more data objects to a heat map color may occur by writing a descriptor to the data object in a “color” variable. In an embodiment, the color may be generated using hexadecimal color values. The description with reference to FIG. 3B provides an example embodiment for mapping one or more data objects to a heat map color.

At 340, the server 130 and/or the client 110 may generate one or more tiles 210 representative of the one or more data objects with a corresponding heat map color. In an embodiment, one tile 210 may correspond to one data object. To generate a tile 210, a graphical user interface image may be rendered. In an embodiment, a graphics processing unit (GPU) may be utilized to generate a tile 210. In an embodiment, one or more tiles 210 may be rendered at a client device 110. The client device 110 may also display the one or more tiles 210 on GUI 112. In an embodiment, one or more tiles may be generated at a server 130. Server 130 may then transmit data to client device 110, allowing client device 110 to render the one or more tiles 210.

In an embodiment, tile 210 may be generated based on information associated with a data object. For example, tile 210 may display data object variable information in data object display 212. In an embodiment, tile 210 may be generated such that a tile area 216 depicts the heat map color of the tile determined in 330. The heat map color allows a user to quickly view the tile 210 and understand how the underlying data object compares to other data objects in a dataset.

In an embodiment, tile 210 may include command interface 214, allowing users to interact and manipulated data object variable information. In an embodiment, command interface 214 may be common across one or more tiles 210. Command interface 214 may be generated independently from variable information associated with a data object. In an embodiment, command interface 214 may depend on the data object variable information. For example, in an embodiment where an administrator is reviewing expense reports and a data object represents an expense report, an expense report may have already been accepted or rejected. In an embodiment, based on the prior acceptance or rejection a different command interface 214 may be generated for each tile 210. For example, icons 220-240 from FIG. 2B may be unavailable and/or not generated if an expense has already been accepted or rejected.

At 350, the server 130 and/or the client 110 may arrange the one or more tiles on a graphical user interface. In an embodiment, arranging the one or more tiles 210 on a graphical user interface includes displaying the tiles 210 so that a user can view the tiles 210. For example, the tiles 210 may be arranged on GUI 112 of a client device 110. In an embodiment, arranging the one or more tiles 210 may also include placing the tiles 210 in locations on a display screen such that the tiles 210 are easily viewable by a user and may be utilized to identify information associated with the data objects. In an embodiment, the size of GUI 112 or screen display of the tiles 210 may be used to determine how to arrange the one or more tiles 210. For example, the tiles 210 may be arranged in rows and columns. Depending on the vertical and/or horizontal size of the GUI 112, some tiles 210 may be hidden until a user interacts with the tiles 210 to view more tiles 210. Different tile 210 sizes and arrangements may allow users to customize their view of the data objects as well as further explore the data.

In an embodiment where method 300 is used to generate tiles 210 depicting expense reports, the one or more tiles 210 may be arranged from the highest expense amount to the lowest expense amount. Further, the tiles 210 may be colored such that the tile 210 displaying the data object with highest expense amount displays a red tile area 216 and the tile 210 displaying the data object with lowest expense amount displays a green tile area 216.

As explained above, the steps of method 300 may be performed in numerous different orders. For example, tiles 210 may be generated before the one or more data objects are sorted.

FIG. 3B is a flowchart illustrating a method 330 for mapping data objects to a color, according to some embodiments. Method 330 may be used to generate a heat map configuration for tiles 210. Method 330 shall be described with reference to FIGS. 1, 2A-2B, and 3A. However, method 330 is not limited to that example embodiment.

Method 330 may be performed by processing logic that may comprise hardware (e.g., circuitry, dedicated logic, programmable logic, microcode, etc.), software (e.g., instructions executing on a processing device), or a combination thereof. In an embodiment, method 330 may be performed by a client device 110. In an embodiment, method 330 may be performed by a server 130. It is to be appreciated that not all steps may be needed to perform the disclosure provided herein. Further, some of the steps may be performed simultaneously, or in a different order than shown in FIG. 3B, as will be understood by a person of ordinary skill in the art.

At 331, server 130 and/or client 110 may receive the one or more data objects, wherein the data objects include at least one common numerical variable with a corresponding numerical value. In an embodiment, the data objects may be received from a database 140 over a network 120. The data objects may be a set of variables organized by a common variable. The variables may include alphabetic information, numeric information, Boolean values, alphanumeric information, textual information, image information, video information, and/or audio information. A dataset may refer to one or more data objects that are grouped together. In an embodiment, a dataset may contain data objects that share a common numerical variable. For example, in an expense report embodiment, data objects may be expense receipts and the amount of the expense may be the common numerical variable. Each data object in a dataset may store an associated numerical value associated with the common numerical variable, such as, for example, $3000 for the amount of the expense. If method 330 is used in the performance of method 300, 330 may be similar to 310 as described in FIG. 3A.

At 332, the server 130 and/or client 110 may calculate the mean of the numerical values of the one or more data objects. The mean may be the average value for the common numerical variable. In an embodiment, the mean may be calculated by performing a summation of the numerical values and dividing the summation by the number of data objects in the dataset.

At 333, the server 130 and/or client 110 may divide the dataset into a first subset including data objects with a common numerical variable value above the mean and a second subset including data objects with a numerical variable value below the mean. In an embodiment, creating two subsets allows for scaling of two different colors. This scaling is useful in scenarios to highlight the relative magnitude of the values of the data object. In an embodiment, more than two subsets may be generated based on other statistics of the numerical values, such as, for example, the variance, one or more standard deviations, and/or the median value. In an embodiment where a data object value equals the mean, a default categorization may be used. The equivalent data object may be labeled into a third subset or may be placed in the first or second subset.

At 334, the server 130 and/or client 110 may scale each of the data objects of the first subset to a shade of a first color and, at 335, each of the data objects of the second subset may be scaled to a shade of a second color. Scaling the data objects may allow a user to quickly identify values greater than the mean as well as values less than the mean. Scaling the data object based on shades of colors may also represent relative magnitudes of the numerical values, which may allow a user to quickly ascertain a relative value based on the shade.

In an embodiment, the scaling of the first and second subsets may be performed using a spectrum of colors including red, yellow, and green. For example, the color yellow may be a mid-point of the numerical values and represent values closest to the mean. The color red may represent higher values, such as values from data objects in the first subset. The color green may represent lower values, such as values from data objects in the second subset. In an embodiment, data object values from the first subset may be scaled from highest to lowest and from red to yellow. Data object values from the second subset may be scaled from lowest to highest from green to yellow. This scaling may occur in a linear manner based on hexadecimal and/or decimal color value.

For example, the scaling of data objects to a shade of a color may be generated using the red-green-blue (RGB) palette. To scale from red to yellow using the RGB palette, decimal values may be utilized. Red may be displayed using the decimal values (255, 0, 0) while yellow may be displayed using the decimal values (255, 255, 0). For scaling, the decimal value may be altered to reflect decimal values (255, X, 0), where X is a variable used for scaling and selecting a color. To scale from green to yellow using the RGB palette, decimal values may also be utilized. Green may be displayed using the decimal values (0, 255, 0) while yellow may be displayed using the decimal values (255, 255, 0). For scaling, the decimal value may be altered to reflect decimal values (X, 255, 0), where X is a variable used for scaling and selecting a color.

To calculate the value for “X” for values above the mean, a first function may be used:

X=(255)*(max−value)/(max—min)

In this equation, the variable “value” may represent the value of the data object being analyzed and for which a shade of a color is being generated. The variable “min” may represent the minimum value of the subset being analyzed. The variable “max” may represent the maximum value of the subset being analyzed. By applying this function to each data object at 334, a color may be generated depending on whether the data object maintains a value above the mean of values in the dataset of data objects.

To illustrate, in an embodiment, the data objects received at 331 may represent expense reports with a common numerical variable being the amount of the expense. In an embodiment, there may be six data objects in a dataset. The six data objects may have an associated expense amount value. For example, the six values may be $100, $200, $300, $400, $500, and $600. At 332, the mean of these values may be calculated and may be $350. At 333, a first subset may be created with the three data objects associated with the values $600, $500, and $400 because those values are above the mean. A second subset may be created with the three remaining data objects associated with the values $100, $200, and $300.

At 334, the first subset may be examined to determine a shade of a first color. In an embodiment, because the values are above the mean, the data objects may be scaled to a shade of the color red. For example, starting with the $600 value, the above function may be applied, with the value being $600, the min being $400, and the max being $600. Solving for X yields 0 as the decimal value. In this case, applying the other RGB palette decimal values, the data object displaying the $600 may be scaled to (255, 0, 0), which may be red.

The same function may be performed for the $500 and $400 values. Taking the $500 value, the above function may be applied the value being $500, the min being $400, and the max being $600. Solving for X yields 127.5. In an embodiment using the RGB palette, this value may be rounded to the nearest whole number to generate a decimal value such as, for example, 128 and a final RGB palette of (255, 128, 0). Performing this calculation for the $400 value may yield a final RGB palette of (255, 255, 0), which may represent the color yellow. This embodiment provides a process for scaling each data object to a shade of a first color at 334.

Turning to scaling the second subset to a second color at 335, a different equation may be used for values below the mean. This equation may be:

X=(255)*(value−min)/(max−min)

At 335, the second subset may be examined to determine a shade of a second color. In an embodiment, because the values are below the mean, the data objects may be scaled to a shade of the color green. For example, starting with the $100 value, the above function may be applied, with the value being $100, the min being $100, and the max being $300. Solving for X yields 0 as the decimal value. In this case, applying the other RGB palette decimal values, the data object displaying the $100 may be scaled to (0, 255, 0), which may be green.

The same function may be performed for the $200 and $300 values. Taking the $200 value, the above function may be applied the value being $200, the min being $100, and the max being $300. Solving for X yields 127.5. In an embodiment using the RGB palette, this value may be rounded to the nearest whole number to generate a decimal value such as, for example, 128 and a final RGB palette of (128, 255, 0). Performing this calculation for the $300 value may yield a final RGB palette of (255, 255, 0), which may represent the color yellow. This embodiment provides a process for scaling each data object to a shade of a second color at 335.

In an embodiment, the generated colors and/or RGB palette data may be stored as information associated with each data object. This information may be utilized by a client device 110 to generate a tile 210. Each tile 210 depicting a data object may display the associated RGB palette as a color in tile area 216.

Although in an embodiment provided, the color palette utilized is for a red-yellow-green combination, different colors may be utilized. The data objects may also be organized and sorted into different configurations.

At 336, the server 130 and/or client 110 may associate the one or more data objects with the determined color. In an embodiment, associating the determined color in 334 and 335 with the data object may include one or more processors writing a variable value to each data object reflecting an RGB decimal value. In an embodiment, a GUI 112 may display the data objects using tiles 210 and color tile area 216 based on the color determined.

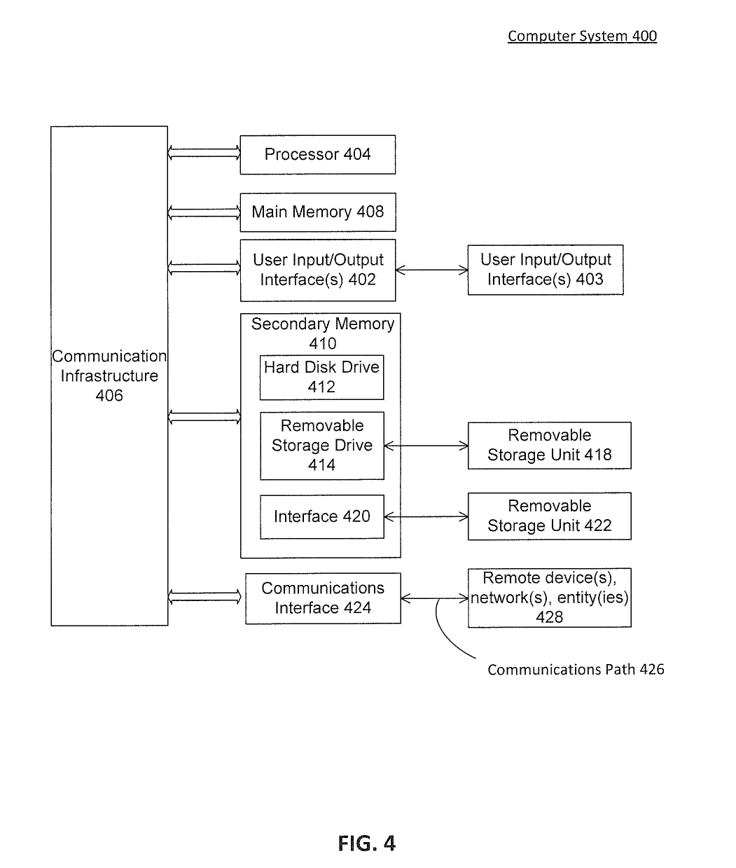

Various embodiments can be implemented, for example, using one or more computer systems, such as computer system 400 shown in FIG. 4. One or more computer systems 400 (or portions thereof) can be used, for example, to implement methods 300 and 330 of FIGS. 3A and 3B.

Computer system 400 can be any well-known computer capable of performing the functions described herein.

Computer system 400 includes one or more processors (also called central processing units, or CPUs), such as a processor 404. Processor 404 is connected to a communication infrastructure or bus 406.

One or more processors 404 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 403, such as monitors, keyboards, pointing devices, etc., that communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use embodiments using data processing devices, computer systems and/or computer architectures other than that shown in FIG. 4. In particular, embodiments may operate with software, hardware, and/or operating system implementations other than those described herein.

It is to be appreciated that the Detailed Description section, and not the Abstract section, is intended to be used to interpret the claims. The Abstract section may set forth one or more but not all exemplary embodiments as contemplated by the inventor(s), and thus, are not intended to limit the disclosure or the appended claims in any way.

While the disclosure has been described herein with reference to exemplary embodiments for exemplary fields and applications, it should be understood that the scope of the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of disclosed inventions should not be limited by any of the above-described exemplary embodiments, but should be defined only in accordance with the following claims and their equivalents.

What is claimed is:

1. A computer-implemented method, comprising:
receiving one or more data objects, wherein the one or more data objects include at least one common variable and wherein each of the one or more data objects includes a value corresponding to the at least one common variable;
sorting the one or more data objects based on the value of the at least one common variable of each data object of the one or more data objects;
associating each data object of the one or more data objects with an attribute based on the value of the common variable of each data object of the one or more data objects; and
generating one or more graphical user interface tiles depicting each data object of the one or more data objects, wherein the one or more graphical user interface tiles depict the attribute associated with each data object of the one or more data objects.

2. The computer-implemented method of claim 1, wherein the attribute is a color.

3. The computer-implemented method of claim 1, wherein the common variable is a numerical variable.

4. The computer-implemented method of claim 1, further comprising arranging the one or more graphical user interface tiles on a graphical user interface display in a row and column configuration.

5. The computer-implemented method of claim 1, wherein the one or more graphical user interface tiles include a command interface.

6. The computer-implemented method of claim 1, wherein associating each of the data objects of the one or more data objects with the attribute further comprises calculating a color value based on a linear function of one or more values associated with the one or more data objects.

7. The computer-implemented method of claim 1, wherein associating each of the data objects of the one or more data objects with the attribute further comprises:
calculating a mean of the values of the one or more data objects; and
grouping the one or more data objects into a first subset including data objects with a value above the mean and a second subset including data objects with a value below the mean.

8. The computer-implemented method of claim 7, wherein associating each of the data objects of the one or more data objects with the attribute further comprises:
associating data objects grouped in the first subset with a shade of a first color; and
associating data objects grouped in the second subset with a shade of a second color.

9. The computer-implemented method of claim 1, wherein the at least one common variable is a monetary amount.

10. A system, comprising:
a memory; and
one or more processors coupled to the memory and configured to:
receive one or more data objects, wherein the one or more data objects include at least one common variable and wherein each of the one or more data objects includes a value corresponding to the at least one common variable;
sort the one or more data objects based on the value of the at least one common variable of each data object of the one or more data objects;
associate each data object of the one or more data objects with an attribute based on the value of the at least one common variable of each data object of the one or more data objects; and
generate one or more graphical user interface tiles depicting the each data object of the one or more data objects wherein the one or more graphical user interface tiles depict the attribute associated with each data object of the one or more data objects.

11. The system of claim 10, wherein the attribute is a color.

12. The system of claim 10, wherein the at least one common variable is a numerical variable.

13. The system of claim 10, wherein the one or more processors are further configured to arrange the one or more graphical user interface tiles on a graphical user interface display in a row and column configuration.

14. The system of claim 10, wherein the one or more graphical user interface tiles include a command interface.

15. The system of claim 10, wherein to associate each of the data objects of the one or more data objects with the attribute, the one or more processors are further configured to calculate a color value based on a linear function of one or more values associated with the one or more data objects.

16. The system of claim 10, wherein to associate each of the data objects of the one or more data objects with the attribute, the one or more processors are further configured to:
calculate a mean of the values of the one or more data objects; and
group the one or more data objects into a first subset including data objects with a value above the mean and a second subset including data objects with a value below the mean.

17. The system of claim 16, wherein to associate each of the data objects of the one or more data objects with the attribute, the one or more processors are further configured to:
associate data objects grouped in the first subset with a shade of a first color; and
associate data objects grouped in the second subset with a shade of a second color.

18. The system of claim 10, wherein the at least one common variable is a monetary amount.

19. A tangible computer-readable device having instructions stored thereon that, when executed by at least one computing device, causes the at least one computing device to perform operations comprising:
receiving one or more data objects, wherein the one or more data objects include at least one common variable and wherein each of the one or more data objects includes a value corresponding to the at least one common variable;
sorting the one or more data objects based on the value of the common variable of each data object of the one or more data objects;
associating each data object of the one or more data objects with an attribute based on the value of the at least one common variable of each data object of the one or more data objects; and
generating one or more graphical user interface tiles depicting each data object of the one or more data objects wherein the one or more graphical user interface tiles depict the attribute associated with each data object of the one or more data objects.

20. The tangible computer-readable device of claim 19, wherein associating each of the data objects of the one or more data objects with the attribute further comprises:
calculating a mean of the values of the one or more data objects;
grouping the one or more data objects into a first subset including data objects with a value above the mean and a second subset including data objects with a value below the mean;
associating data objects grouped in the first subset with a shade of a first color; and
associating data objects grouped in the second subset with a shade of a second color.
